(19) United States
(12) Patent Application Publication
(10) Pub. No.: US 2015/0112465 A1
(43) Pub. Date: Apr. 23, 2015

(54) Method and Apparatus for On-Demand Conversion and Delivery of Selected Electronic Content to a Designated Mobile Device for Audio Consumption

(71) Applicant: Joseph Michael Quinn, Crofton, MD (US)

(72) Inventor: Joseph Michael Quinn, Crofton, MD (US)

(21) Appl. No.: 13/998,351

(22) Filed: Oct. 22, 2013

(51) Int. Cl. G06F 17/30

(52) U.S. Cl. CPC G06F 17/3074
USPC 700/94

(57) ABSTRACT

The present invention pertains to methods and apparatus for selecting content displayed on a personal computer, smart phone or other information appliance, saving the electronic content in a designated memory, and then listening to the electronic content as an audio file at a time chosen by the user.

### CROSS-REFERENCE TO OTHER RELATED PATENT APPLICATIONS

None.

### FEDERALLY SPONSORED RESEARCH OR DEVELOPMENT

None.

### FIELD OF THE INVENTION

The present invention pertains to methods and apparatus for selecting content displayed on an information appliance, such as a smartphone or some other device, mobile or otherwise. One or more files of electronic content is selected, and then a specially designed software program is used to convert the file to a readable text format if the selected file is not a bitmap file. The software program is then used to convert the file to an audio file, and is stored on a local or remote device for playback at a time chosen by the user.

### BACKGROUND OF THE INVENTION

According to Gartner, Inc., over 1.2 billion smartphones and tablet computers were purchased worldwide in 2012. In the same year, over 350 million personal computers were sold worldwide. By 2014, over two billion computing devices are expected to be in use worldwide.

Each day, millions of people employ these devices to access content from the Internet. In some instances, a user will find a news story, a document or some other content which he or she wishes to read, but wants to defer reading until some time in the future. In some instances, it is more convenient for the user to listen to an audio playback of the content, rather than to read it.

No currently available combination of hardware and/or software supplies a convenient method for selecting content, saving it to a designated memory, and then listening to the content at a time selected by the user. The development of such an system would offer great benefits and satisfy a long felt need in the computing and telecommunications industries, and would constitute an advance in those fields business.

### SUMMARY OF THE INVENTION

The present invention comprises methods and apparatus for enabling a user, through a single action, to select electronic content utilizing his or her personal computer, smart phone or some other information appliance; save it to a designated memory; and then listen to an audio reproduction of the content at a time chosen by the user. The content may be saved in the user's device, or may be stored in the Cloud.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 is a view of a first embodiment of the present invention, in which a user views electronic content utilizing a personal computer.

FIG. 2 shows the user downloading a software program, “Add-on” or “App” to personal computer. This software program implements one embodiment of the invention.

FIG. 3 shows the computer display after the software program that implements the present invention has been downloaded. A new button “L2L,” which is an abbreviation for the Listen 2 Later^{SM} WebService, now appears in the top right corner of the screen.

FIG. 4 presents a view of the user selecting content that he wishes to listen to at a time of his choice.

FIG. 5 presents a view of the user clicking on the L2L button after selecting the content.

FIG. 6 is a flowchart which illustrates a first embodiment of the invention. Content is identified by the user, then the L2L button is clicked, then the content is converted to a text file if it is bitmap file, then it is converted to an audio file and then the audio file is conveyed to and/or saved in a memory designated by the user.

FIG. 7 displays the final step of this first embodiment, in which the user listens to an audio playback of the electronic content. In FIG. 7, the user listens to the audio file using a smart phone and a connected earpiece.

FIG. 8 reveals a second embodiment of the invention. The user has a smartphone, which receives content via a wireless connection to the Internet, and to a remote server or some other suitable device in the Cloud.

FIG. 9 offers a view of the user downloading the L2L “App” to her smartphone.

FIG. 10 shows that the L2L App is now stored in the smartphone's memory.

FIG. 11 is a view of the user selecting content using the touchscreen of her smartphone.

FIG. 12 is a view of the user activating the L2L feature by touching the L2L button on her smartphone.

FIG. 13 is a flowchart which illustrates the second embodiment of the invention. Content is identified, then the L2L button is clicked, then the content is captured, converted to an audio file and saved in a memory designated by the user.

FIG. 14 displays the final step of this second embodiment, in which the user listens to an audio playback of the electronic content.

FIG. 15 is a schematic block diagram and flowchart which depicts the architecture of one implementation of the invention, which is activated by the single action of clicking the L2L button on the display of their information appliance.

FIGS. 16 through 21 are screenshots that illustrate the operation of one embodiment of the invention.

### A DETAILED DESCRIPTION OF PREFERRED & ALTERNATIVE EMBODIMENTS

### I. A First Embodiment the Invention

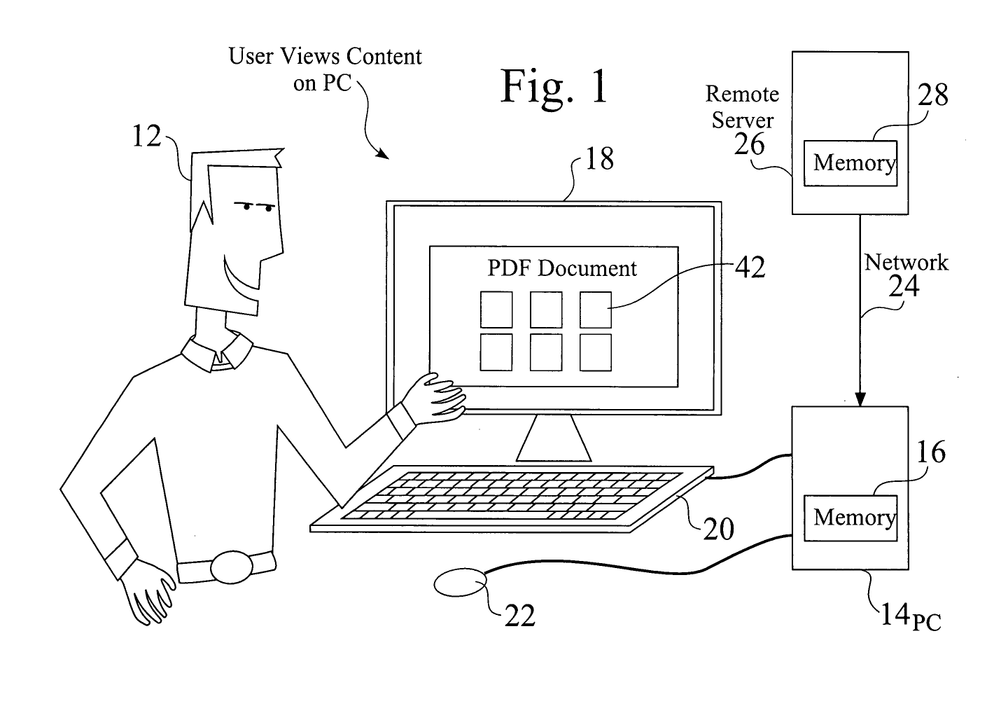

FIG. 1 is a generalized view 10 of one particular embodiment of the present invention. A user 12 is shown operating an information appliance. In this embodiment, the information appliance is a personal computer 14, which includes a non-volatile memory 16. In this Specification, and in the Claims that follow, the term “information appliance” is intended to mean any combination of hardware and software that may be used to process, manipulate, utilize, convey, record, generate, format, display, play and/or view electronic content or data. An information appliance may comprise a personal computer, a laptop, a tablet, a smart phone, a mobile communication device, an MP-3 player or any other suitable combination of hardware and/or software that is capable of being used to implement the present invention.

The personal computer 14 is connected to a monitor or display 18, a keyboard 20 and a mouse 22. In this embodiment, the personal computer 14 is connected to a network 24 that is, in turn, connected to the Internet. The term “network” is intended to encompass any set of connections, whether public or private, which link an information appliance 14 with some other combination of hardware and/or software. In one embodiment, the network is the Internet.

A remote server 26 is also connected to the Internet, or to some other network 24. This connection may be wired or wireless. The remote server 26 includes a non-volatile memory 28. The remote server 26 may be part of the generalized network beyond the user's location which is referred to as “the Cloud.” The term “remote server” 26 is intended to include any combination of hardware and/or software that is connected to a network 24. “The Cloud” refers to any combination of hardware and/or software which is connected to a network that may be accessed by a device operated by the user 12.

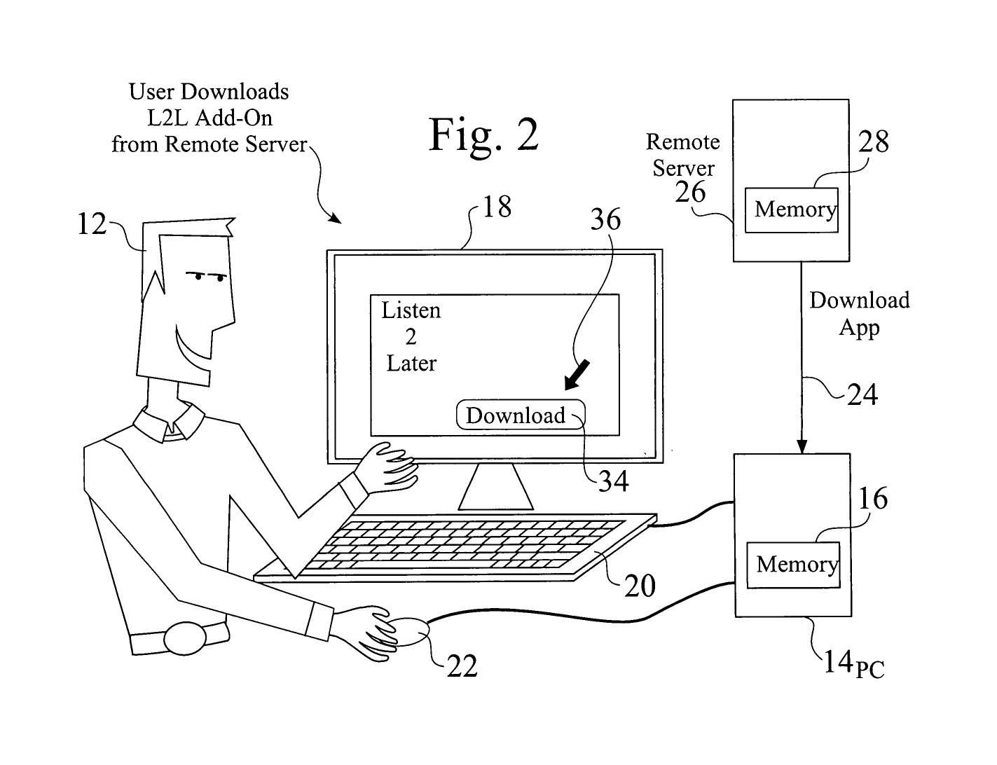

FIG. 2 shows the user 12 viewing his computer monitor 18. His personal computer 14 is running an operating system 30 and a host software application 32. The term “host software application” is intended to include any executable code which allows the user to operate the information appliance 14 and to perform a useful function. In one embodiment, the host software application is browser, which is used to visit webpages, and to search for, to retrieve and to display content. Currently popular browsers include Microsoft Explorers^{SM}, Mozilla Firefox^{SM}, Google Chromes^{SM}, Operas^{SM} and Apple Safaris^{SM}. The present invention may be implemented using a wide variety of compatible browsers.

In another embodiment the host software application may be a word processor, such as Microsoft Words^{SM} or WordPerfect^{SM}. Other host software applications may include, but are not limited to:

### Spreadsheets (e.g., Excel^{SM})

### Databases (e.g., SQL^{SM})

e-mail Programs (e.g., Outlook^{SM})

### Slide Presentation (e.g., PowerPoint^{SM})

### Media Managers (e.g., Windows Media Center^{SM})

### Portable Document Format Programs (e.g., Adobe Acrobat^{SM})

As shown in FIG. 2, the user has logged on to the Listen 2 Later website 33. The monitor 18 presents a screen that includes a download button 34. When the user 12 places his cursor 36 over the download button 34, and then clicks on the download button 34, his browser connects to the L2L website 33, and conveys an Add-on 38 to his personal computer 14 from the memory 28 of the remote server 26, where the Add-on is archived. The Add-on 38 is then stored in the non-volatile memory 16 of his personal computer 14. The memory 16 may be a conventional spinning disc hard drive, a solid state drive, a memory stick or any other suitable non-volatile device for storing a software program. According to Wikipedia, an Add-on is an “installable enhancement” which provides additional features or functionality to a host software application. In this Specification, and in the Claims that follow, the terms “Add-on” and “App” are intended to encompass any software program that modifies, assists or works in combination with a host software application that runs on an information appliance. The Add-on may be downloaded over a network; may be installed from a physical storage device such as a CD-ROM, USB drive or memory stick; or may be placed in a particular device at the factory or at a retail outlet. The Add-on may be agnostic to a host software application, or may be embedded into a host software application. In an alternative embodiment, the L2L Add-on can run independently.

When the L2L Add-on is downloaded and stored in the user's personal computer 14, the memory in the user's personal computer 14 changes state and its condition. The personal computer 14, together with the Add-on 38, are then capable of performing beneficial tasks which could not be accomplished as readily and as easily as before this combination was created by the user 12. The beneficial tasks that are now offered to the user 12 are only obtained through the use of the Add-on 38, which comprises a set specifically designed lines of code. Unlike general purpose software, the Add-on 38 utilized by the present invention requires particular inputs to bring out specific desired results.

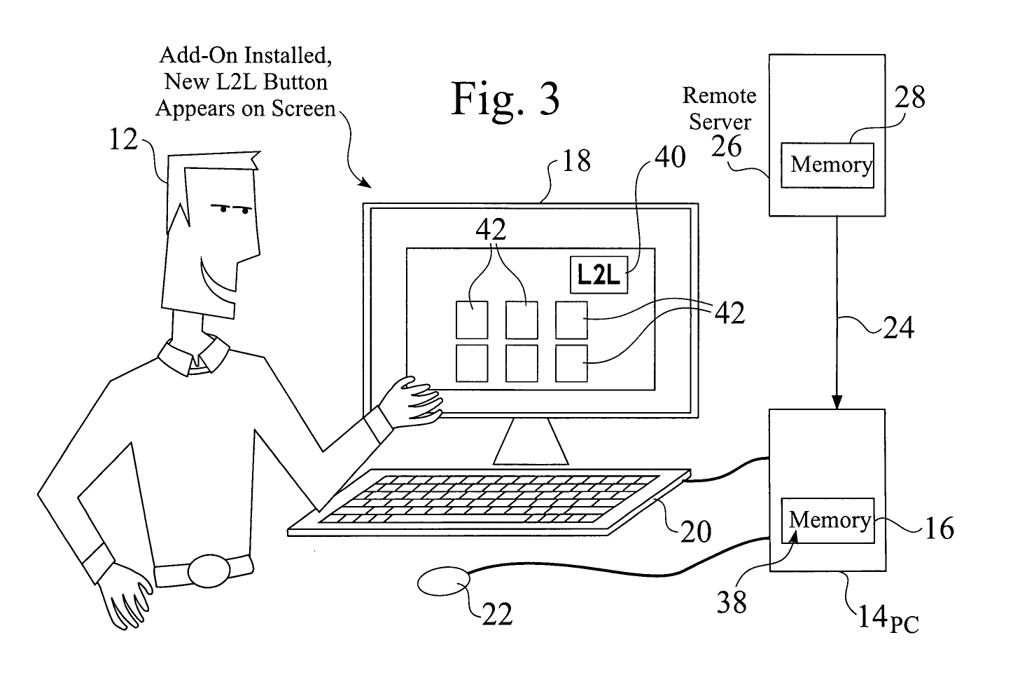

FIG. 3 shows the user's monitor 18 as it displays a host software application 30, plus a new feature, the “L2L” button 40, in the top right corner of the displayed webpage. The user is now ready to employ the L2L invention. The term “button” refers to a portion of the screen, which, when clicked with the user's pointing device, activates the single action L2L function. In an alternative embodiment, the L2L feature may be initiated by voice command, by operating a television remote control or by pressing a key on a keypad.

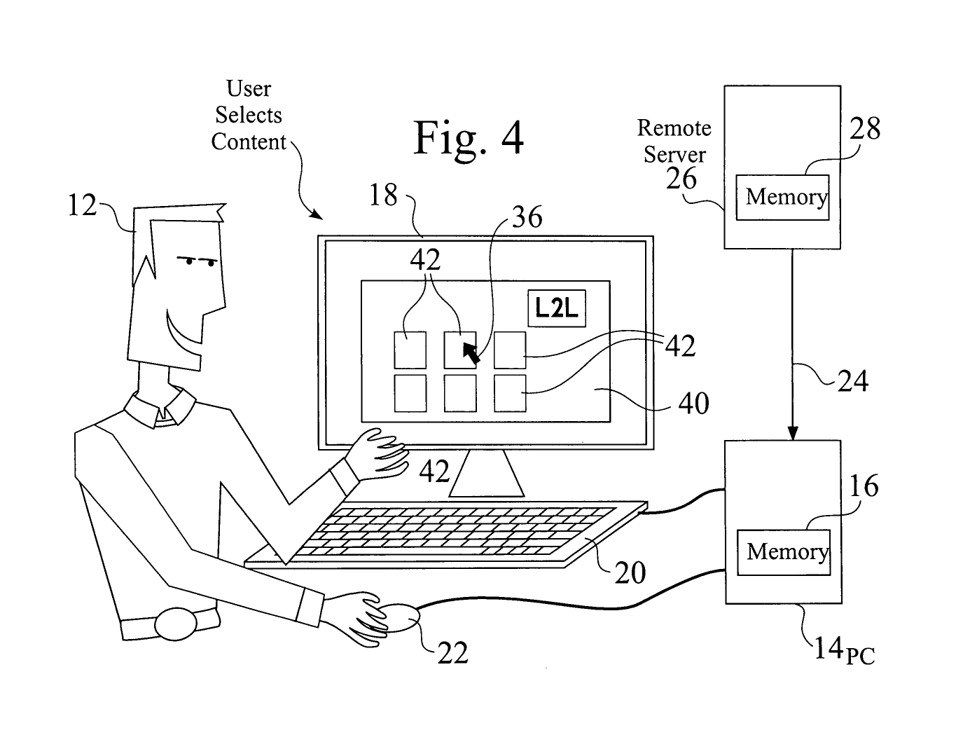

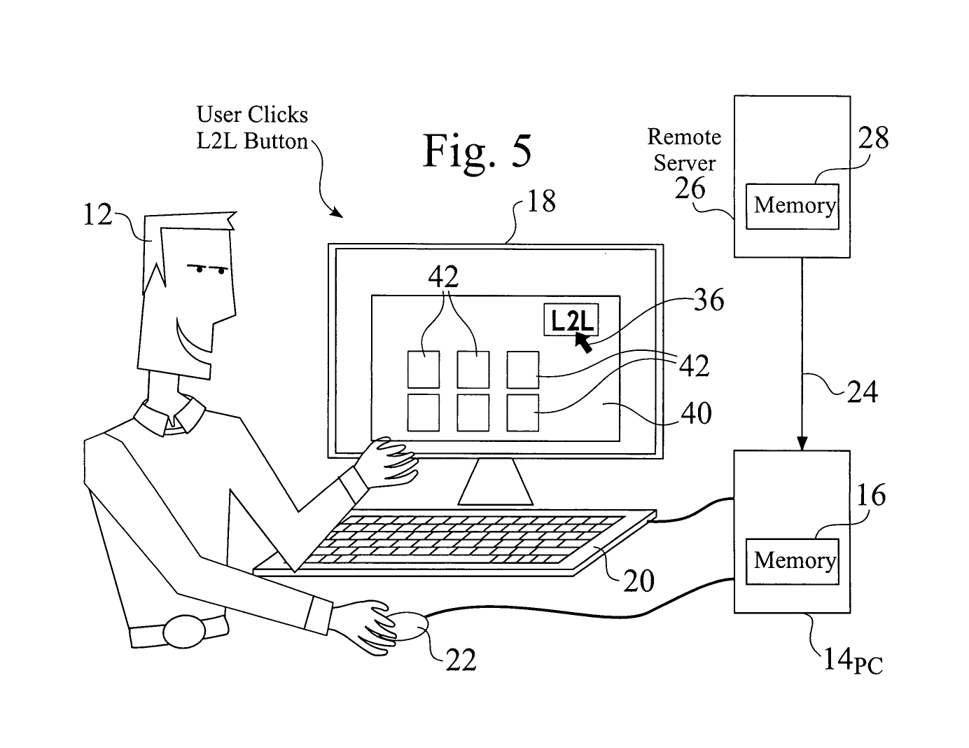

FIG. 4 supplies a view of the user viewing a host software application that presents one or more icons 42 associated with individual files of electronic content. The term “files of electronic content” is intended to include any set of data or information, which, when saved on a storage device, may be referred to as one or more files, or subsets of files. When the user wants to convert one of these content files to an audio file which he may listen to at a later time, he moves the cursor 36 over one or more icons 42. He then clicks on the L2L button 40, as shown in FIG. 5. The L2L Add-on 38 then determines whether the selected file of content is a bitmap file. If the selected file of content is a bitmap file, the L2L Add-on 38 converts the file to a text format. A bitmap file is a file comprising a number of bits, i.e., ones and zeroes. A bitmap file is not a machine-readable text file. Bitmap files may be converted to machine-readable text files using a scanner an Optical Character Recognition (OCR) software. The L2L Add-on 38 then converts the selected text to an audio file, and saves it to a storage device designated by the user 12. In one embodiment of the invention, the audio file is saved to the same information appliance 14 that the user 12 employed to create the audio file. In other embodiments, the user 12 may direct the L2L Add-on 38 to convey the audio file to another device, such as his or her smart phone or e-book reader. In yet another embodiment, the user 12 may instruct the L2L Add-on 38 to store the audio file on some device in the Cloud. One example of a service that allows users to store files of content in the Cloud are Dropbox^{SM} Barracudas^{SM}, Google Cloud Storages^{SM}, Justcloud^{SM}, Mozy^{SM} and Box^{SM}.

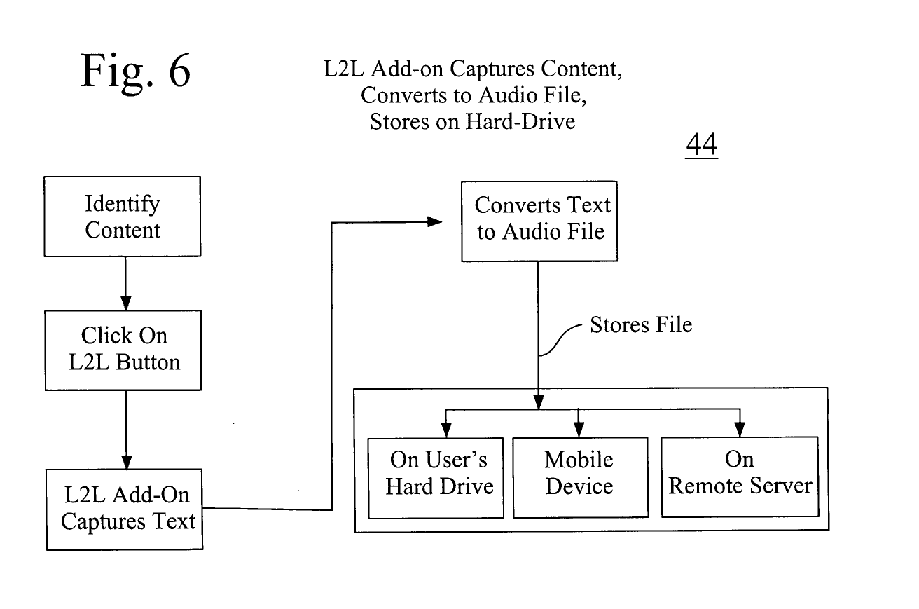

FIG. 6 is a flowchart 44 which illustrates the basic method steps of the first embodiment of the present invention. The user 12 first selects an icon, and then clicks on the L2L button 40. In another embodiment of the invention, the user 12 may simply speak the characters “L2L” into a microphone, and the Add-on 38 may be activated using voice recognition software. This voice recognition software is well known in the art. One popular host software application that provides voice recognition is Dragon Naturally Speaking^{SM}.

After the L2L Add-on 38 has been activated, the content is selected, converted to a text file if the original file is not a machine-readable text file, converted to an audio file, and then saved in the storage device chosen by the user 12. The process of converting a selected file to a machine-readable file is well-known in the art. This process may be accomplished using a popular host software application, Adobe Acrobat^{SM}. If the original file is already a machine-readable file, this first conversion step is skipped.

This embodiment of the present invention provides a method that enables a user 12, taking a single action, to obtain an audio playback of a file that is stored in a designated memory in a way that offers instant access on demand within a host App that is running on the user's mobile device.

In this Specification, and in the Claims that follow, the term “audio file” refers to any file, string or collection of data that may be converted to sound that is within the hearing range of humans. Currently popular audio file formats include MP3, WAV, AIFF, AU and BWF.

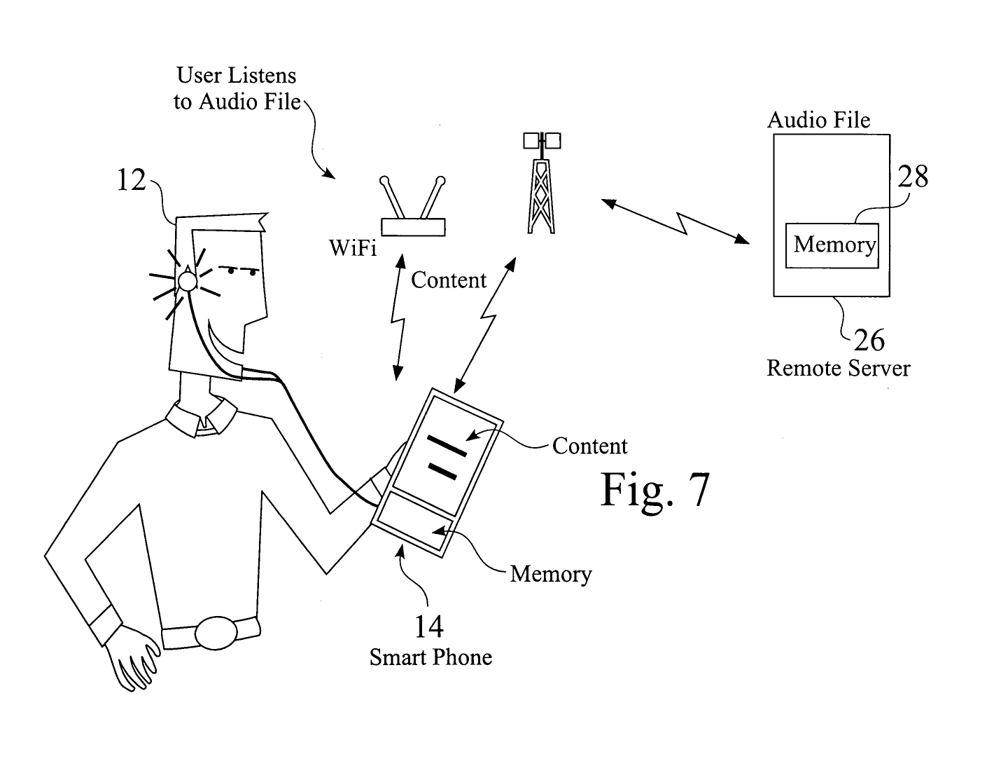

FIG. 7 portrays the final step of the first embodiment of the invention. The user 12 employs an information appliance 14 to listen to an audio file retrieved from a remote server over a network connection.

When the text file is saved in an audio file format, and then stored in a memory, the memory changes state and condition. Whether the audio file is saved on the user's information appliance, or is directed to a mobile device or to a content locker in the Cloud, a memory changes state when the audio file is recorded in its designated location. The machine or device which houses the memory changes state and condition, and is now able to provide the user 12 with an audio playback of the file. This beneficial result is tied to a machine, since the result is only obtained by using the specially designed L2L software program in combination with the user's chosen playback device.

### II. A Second Embodiment of the Invention

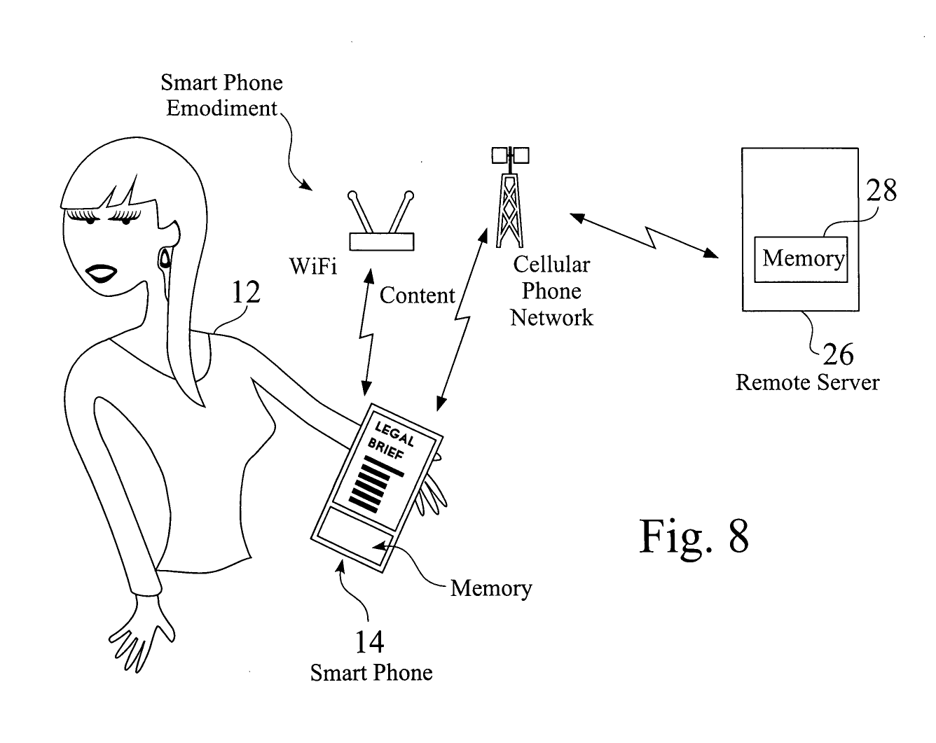

FIGS. 8 through 14 illustrate a second particular embodiment of the invention. This second embodiment is similar to the first embodiment, but is implemented using an information appliance which is a mobile device, such as a smartphone 14. In FIG. 8, the user 12 views electronic content on her smartphone. The user's smartphone is connected to a wireless network, such as a Wi-Fi, Bluetooth or cellular telephone network. The wireless network is also connected to the remote server, which stores an L2L App.

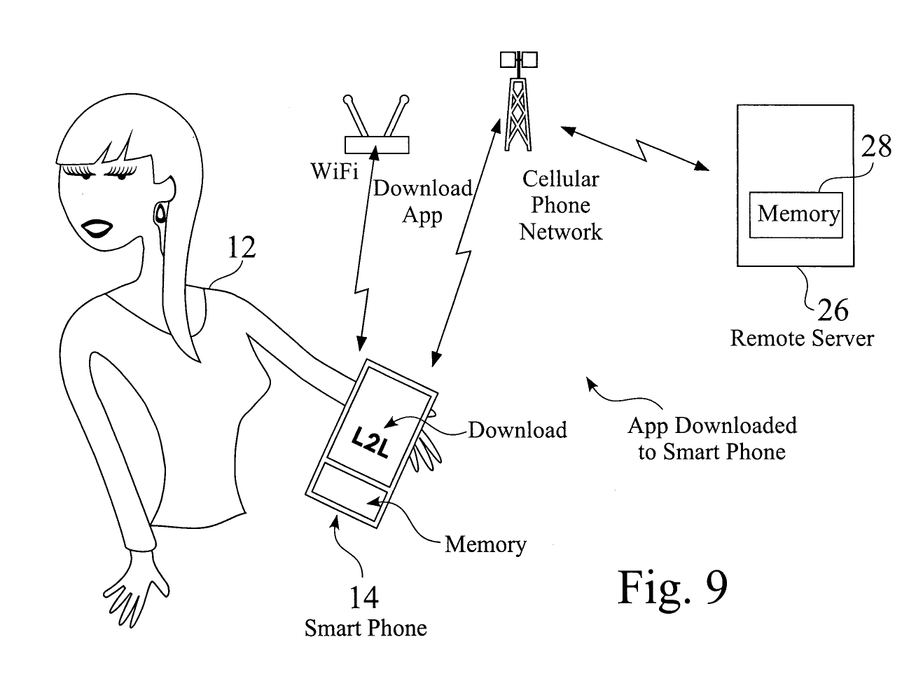

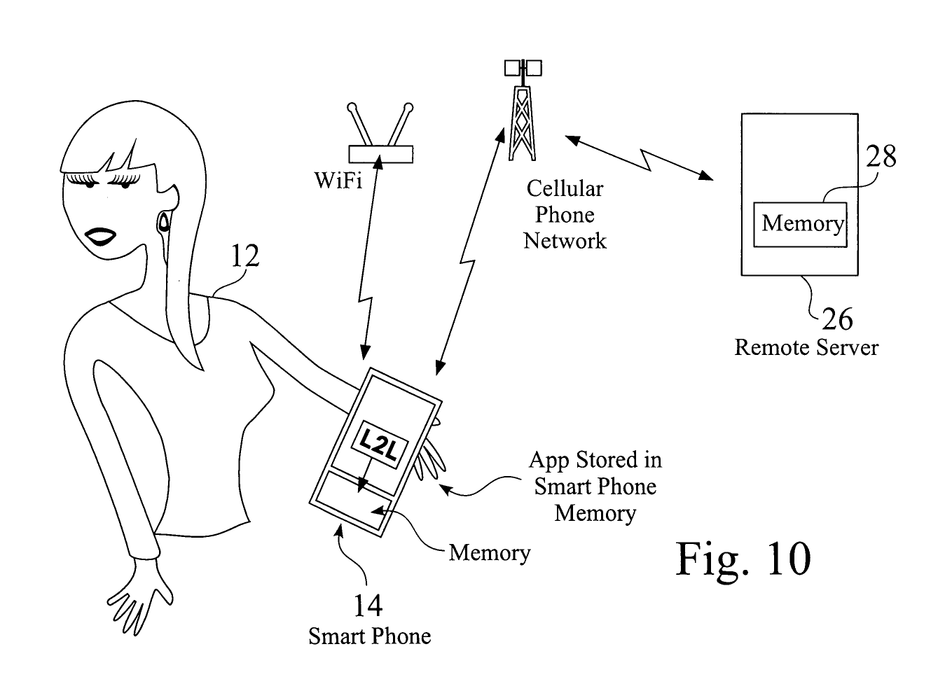

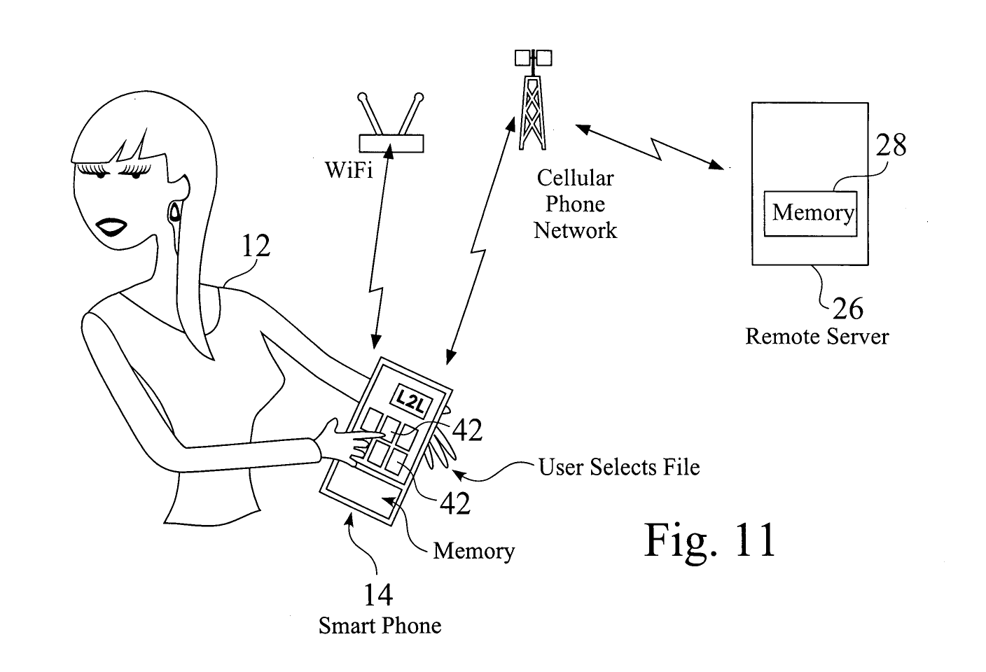

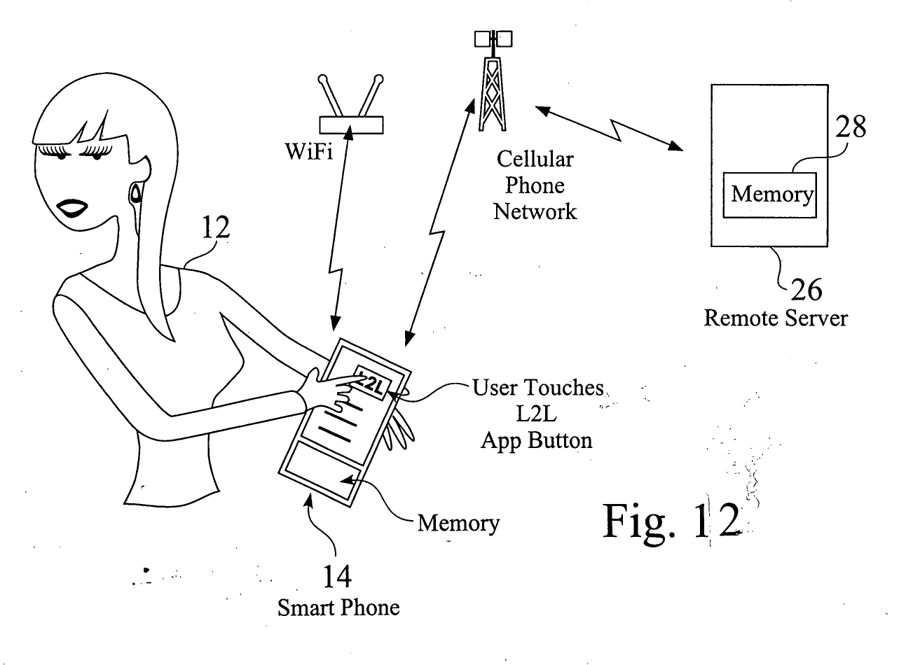

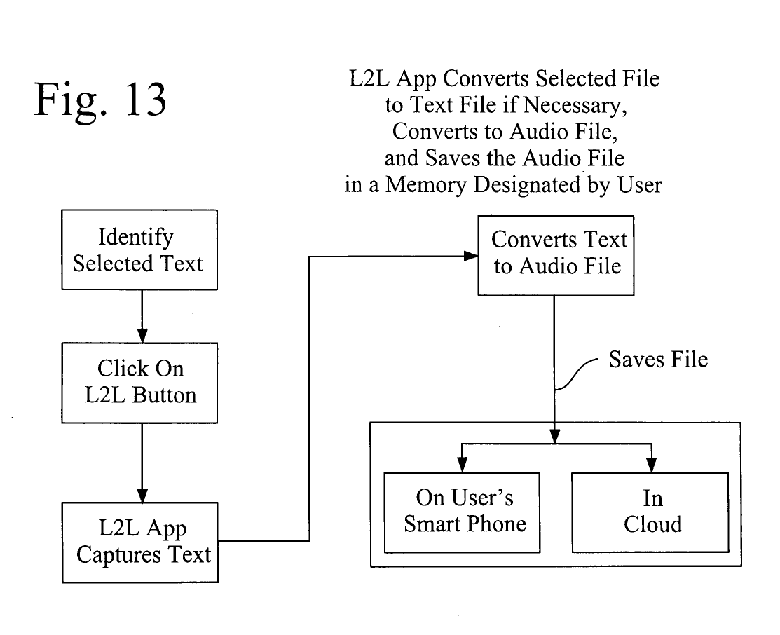

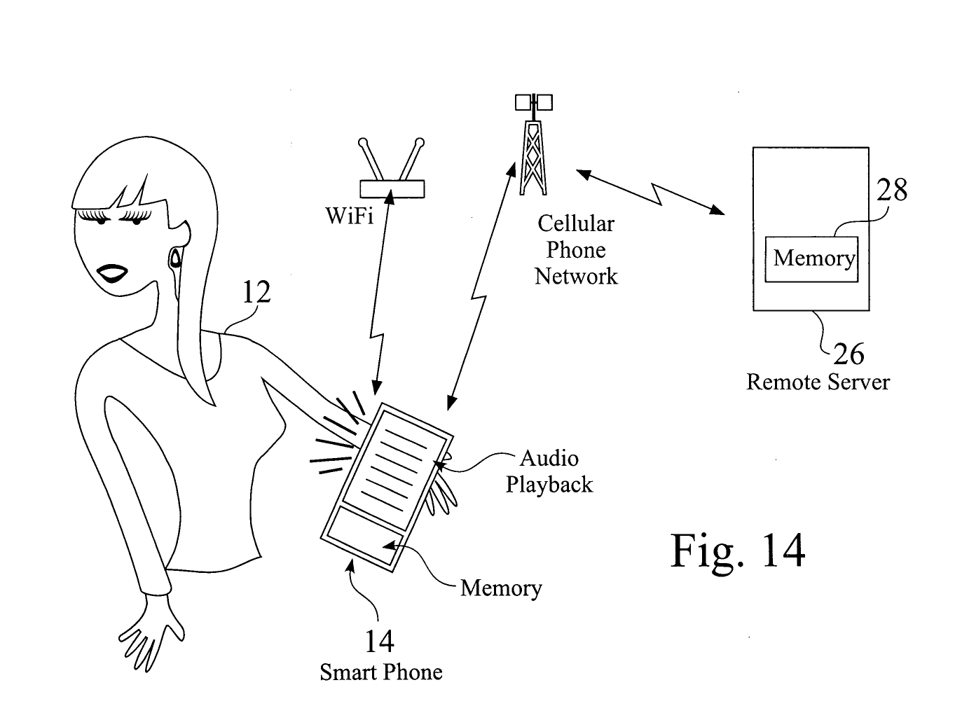

In FIG. 9, the user 12 downloads the L2L App. FIG. 10 shows the display of the user's smartphone after the L2L App has been downloaded and stored in the memory of the user's smartphone. An “L2L” button now appears in the top right corner of the browser screen. In FIG. 11, the user 12 selects an icon, which represents a content file, using the touchscreen on her smartphone display. In FIG. 12, she touches the L2L button, and activates the L2L App. FIG. 13 shows the method steps which are implemented in this second embodiment. Content is selected, converted to a machine-readable text file if necessary, converted to an audio file, and then stored in a location selected by the user 12. The selected content may be a file, a data file subset or an extract of a file, such as a range of data. In FIG. 14, the user 12 listens to a selected audio file at a time which she selects. FIG. 14 also depicts a Wi-Fi hotspot or a cellular phone tower, which may be part of the network.

The L2L App is designed to work with commonly available host mobile Apps, such as iTunes^{SM}, Stitcher^{SM} and Instacast^{SM}.

### III. Additional Features of the Invention

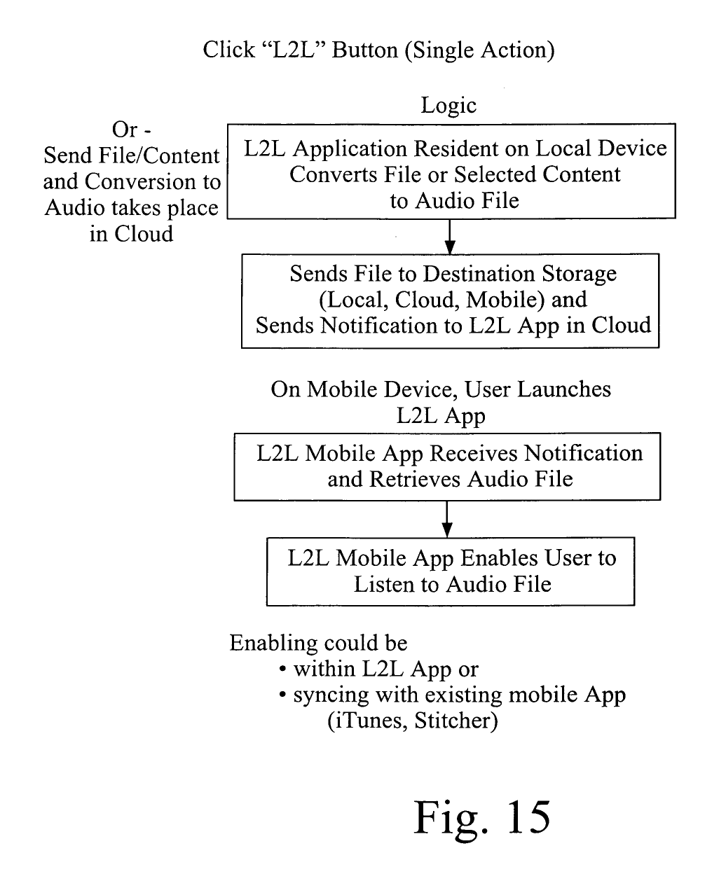

FIG. 15 is a schematic block diagram which illustrates the generalized steps of one embodiment of the invention. In the first step, the L2L App is resident on the user's information appliance, converts a selected file to a text file if necessary, and then converts the text file to an audio file. In the second step, the audio file is sent to a designated storage device. In the third step, the audio file is retrieved from the storage device. In the fourth step, the user's information appliance plays back the audio file. All these steps are accomplished through the initiation of a single action by the user once the L2L Add-on is installed. The user may designate, in advance, a default selection range, such as an entire file, and a default destination, such a mobile device which is ready to play the audio file.

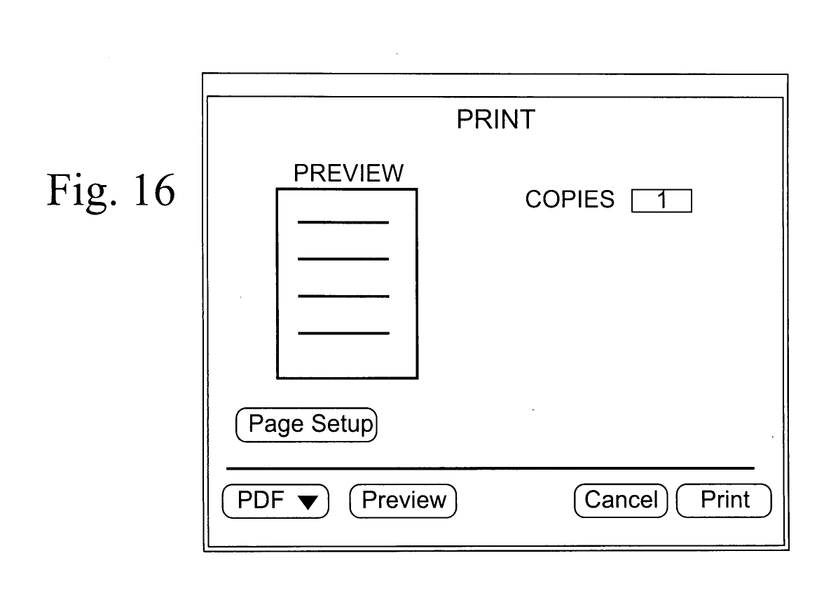

FIGS. 16 through 20 are screen shots which illustrate the operation of one embodiment of the invention. FIG. 16 shows a print screen from a typical host software application that runs on a user's information appliance. A preview of the content of a selected file. Buttons are provided to select a number of copies to be printed, and for page setup settings. A bar situated at the bottom of the screen contains PDF, Preview, Cancel and Print buttons.

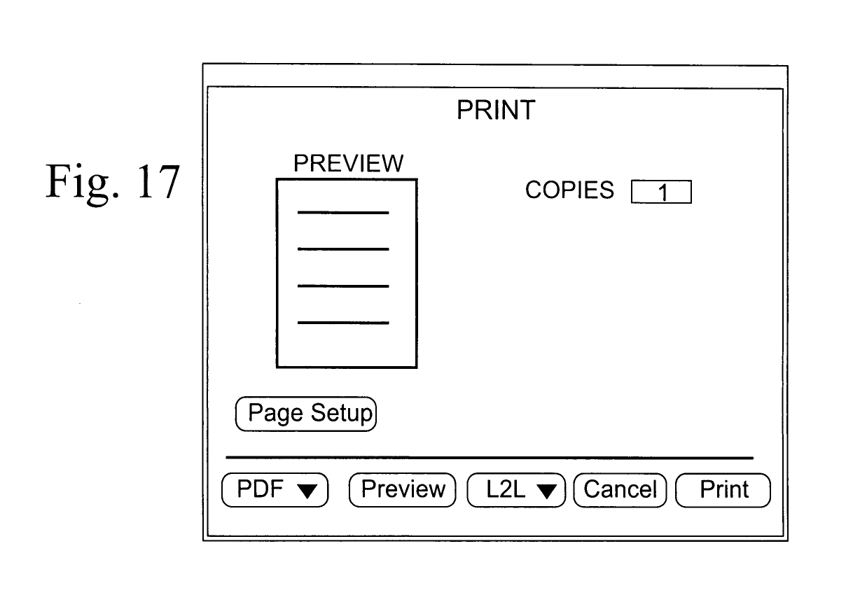

FIG. 17 shows the same screen as depicted in FIG. 16 after the L2L software has been downloaded to or installed on the user's information appliance.

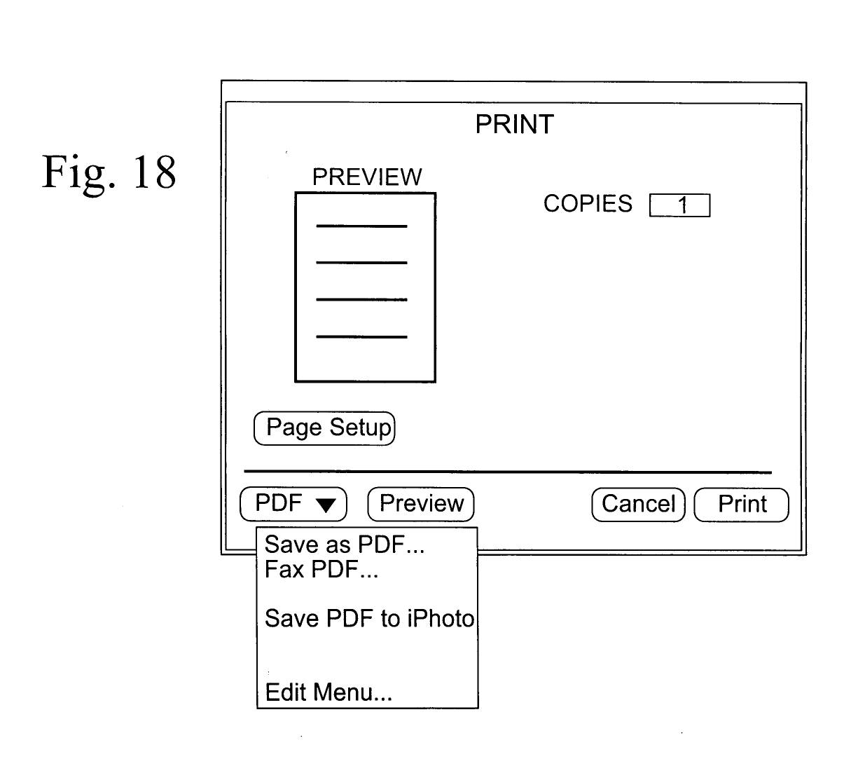

FIG. 18 shows the same screen as depicted in FIG. 16, but also includes a drop down menu that includes further selections such as Save as PDF, Fax PDF, Save PDF to iPhoto and Edit Menu.

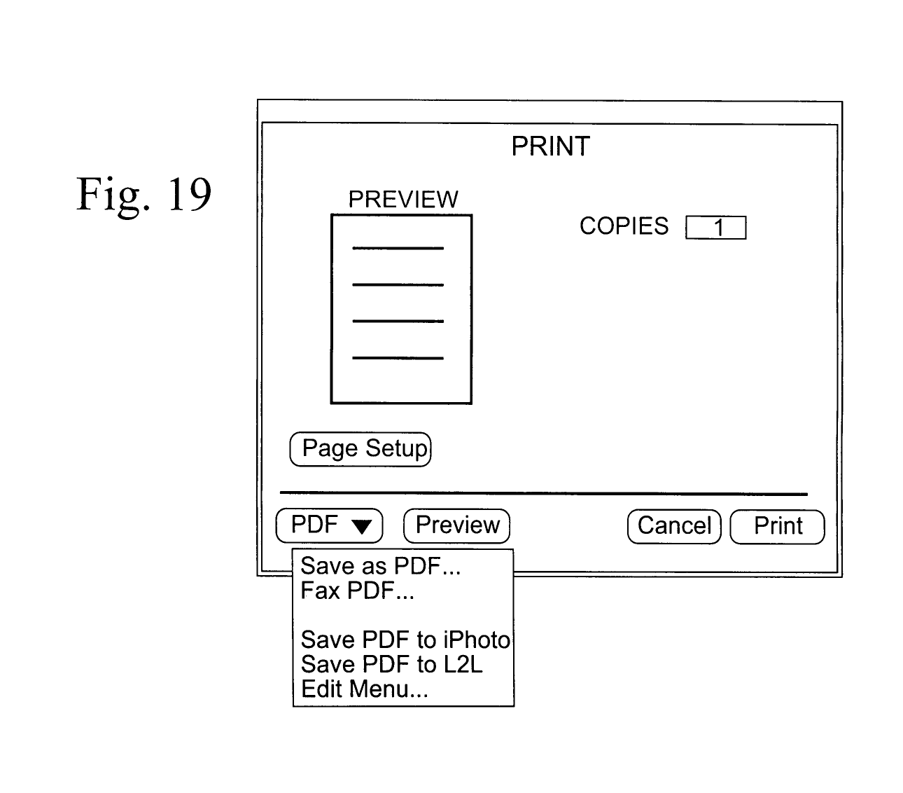

FIG. 19 is a view of the same screen as depicted in FIG. 18, but now includes the new single action button “Save PDF to L2L” in the drop-down menu. This is an example of an Add-on being embedded into a host software application.

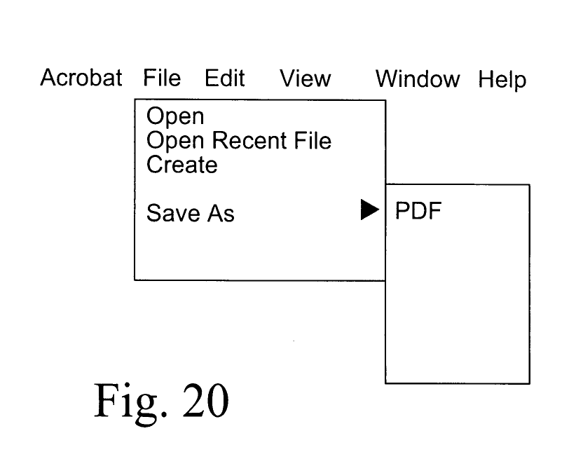

FIG. 20 supplies an illustration of a typical screen within a document application, which provides a file format that cannot be altered without leaving an electronic footprint.

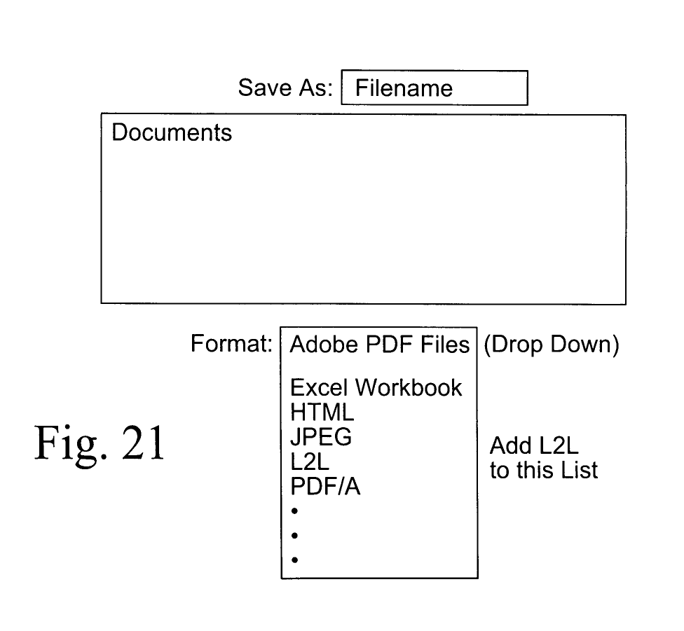

FIG. 21 is a view of an application which provides a file format that cannot be altered without leaving an electronic footprint. FIG. 21 offers a view of a typical screen within that document application, and which allows the selection of a single action, via the L2L choice in the pop-down menu. This is another example of an Add-on being embedded into a host software application.

### IV. Benefits of the Invention

Each day, millions of people employ information appliances such as smart phones to access content either from the Internet or from applications, such as Microsoft Words^{SM} or Adobe Acrobats^{SM}. In some instances, a user 12 will find a news story, a document or some other content which he or she wishes to read, but wants to defer reading until some time in the future. In some instances, such as during exercise or travel, it is more convenient for the user 12 to listen to an audio playback of the content, rather than to read it.

The present invention provides a convenient, single-action method and apparatus for selecting content within a browser or text viewing host software application, saving it to a designated memory and then listening to the content at a time selected by the user 12 on a mobile device. Attorneys of all ages typically have to read a large quantity of documents—legal briefs and pleadings, and the like. They want and need exercise. The present invention affords them the ability to, in a single action, send to their mobile device certain written electronic content that they then can consume via audio while exercising. Other professionals, such as doctors and any other professionals that have the on-going necessity for continuing-education, lack the free-time to consume all the required content by reading it. They need and want a single action method to send to their mobile device content they can consume via audio on the go from their mobile device.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Method & Apparatus for On-Demand Conversion & Delivery of Selected Electronic Content to a Designated Mobile Device for Audio Consumption that have been disclosed above are intended to educate the reader about preferred embodiments of the invention, and are not intended to constrain the limits of the invention or the scope of Claims.

### LIST OF REFERENCE CHARACTERS

12 User
14 Information Appliance
16 Memory
18 Display
20 Keyboard
22 Mouse
24 Network
26 Remote Server
28 Memory
30 Operating System
32 Host software application
33 L2L Website
34 Download Button
36 Cursor
38 Downloaded software program stored in memory of information appliance
40 “L2L” Button
42 Icon representing file of content
44 Schematic diagram illustrating first embodiment

What is claimed is:

1. A method comprising the steps of:
providing an information appliance; said information appliance having a display for depicting a listing of files of electronic content;
installing a software program on said information appliance;
said software program being specifically designed to add an on-screen button for said user;
said software program also being specifically designed to automatically convert a selected one of electronic content to a readable text file format if said one of said files is a bitmap file;
said software program also being specifically designed to convert one of said files of electronic content to an audio file;
selecting one of said files of electronic content;
converting one of said files to a readable text file format if said one of said files is a bitmap file using said software program;
converting one of said files which is in said readable text file format to an audio file using said software program;
selecting a destination for said audio file using said software program; and
conveying said audio file to said destination for immediate playback of said audio file at a time selected by a user as a result of a single action initiated by said user.

2. A method as recited in claim 1, in which said single action is said user clicking said on-screen button.

3. A method as recited in claim 1, in which said single action is said user speaking a verbal command.

4. A method as recited in claim 1, in which said single action is said user operating a television remote control.

5. A method as recited in claim 1, in which said single action is said user depressing a key on a keypad.

6. A method as recited in claim 1, in which destination is a mobile device.

7. A method as recited in claim 1, in which said software program is downloaded to said information appliance.

8. A method as recited in claim 1, in which said listing of files of electronic content is represented as a plurality of icons depicted on said display.

9. A method as recited in claim 1, further comprising the step of:
conveying said audio file to a remote server.

10. A method as recited in claim 1, further comprising the step of:
retrieving said audio file from said remote server for local playback.

11. A method as recited in claim 1, in which
said software program runs independently of a host software application.

12. A method as recited in claim 1, in which
said software program is embedded in a host software application.

13. An apparatus comprising:
a first information appliance;
said first information appliance including a first memory; said first memory storing a file of content;
said first memory including a software program that enables a user, in a single action initiated by a user operating said first information appliance, to select said file of content, to convert said file of content to a machine-readable text file if necessary, and to convert said machine-readable text file to an audio file;
a second information appliance;
said first information appliance including a second memory; said second memory for recording said audio file; and
said first information appliance routing said audio file to said second information appliance over a network; and
said routing is performed in response to said single action.

14. An apparatus as recited in claim 13, in which said first and said second memory are the same device in the same information appliance.

15. An apparatus as recited in claim 13, in which said first information appliance is a mobile device.

16. An apparatus as recited in claim 13, in which said second information appliance is a mobile device.

17. An apparatus as recited in claim 13, in which said second information appliance is a remote server.

18. An apparatus as recited in claim 13, in which said first and said second information appliances are connected by a network.
